(19) United States
(12) Patent Application Publication
(10) Pub. No.: US 2004/0258176 A1
(43) Pub. Date: Dec. 23, 2004

(54) Precorrection of nonlinear distortion with memory

(75) Inventors: Anders S. Mattsson, Mason, OH (US); Carlos Abascal, Middletown, OH (US); Wayne Douglas Duello, Hamilton, OH (US); Ky Thoai Luu, Mason, OH (US)

Correspondence Address: TAROLLI, SUNDHEIM, COVELL & TUMMINO, LLP, Suite 1111, 526 Superior Avenue, Cleveland, OH, 44114, US

(73) Assignee: Harris Corporation

(21) Appl. No.: 10/465,060

(22) Filed: Jun. 19, 2003

(51) Int. Cl. H04L 27/04

(52) U.S. Cl. 375/297

(57) ABSTRACT

A system and method are provided for providing nonlinear precorrection to an input signal. A plurality of nonlinear function blocks each receive a constituent signal, derived from the input signal. Each constituent signal has an associated value and an associated delay. The nonlinear function blocks output an intermediate signal having a value equal to that of an associated memoryless nonlinear function evaluated at the value of the constituent signal. A summation function sums the plurality of intermediate signals to obtain a system output.

### BACKGROUND OF THE INVENTION

1. Field of the Invention

This invention relates to the field of signal correction in a communication system, and, more particularly, to precorrection of an information-carrying input signal in a system having a source of nonlinear distortion.

2. Description of the Prior Art

Correction for amplifiers has attracted a significant amount of interest recently, mainly due to increasingly strict requirements for spectral purity and demands for increased efficiency. With digital signal processing (DSP) circuits becoming less expensive and more powerful, predistortion of an information carrying signal has become a popular means of meeting these requirements.

Predistortion is relatively straightforward in a memoryless system. In a memoryless system, the output of the system at a given time depends solely on the input to the system at the given time. A solid first approximation of the characteristics of a memoryless amplifier can be provided by the transfer curves (AM-AM/PM) of the amplifier. Predistortion in such systems is well known in the art.

Most practical amplifiers, however, have memory, in the sense that prior inputs have an effect on the present output. Such a system can be only roughly approximated by memoryless system. One approach for dealing with nonlinear systems with memory involves the Volterra series. When dealing with high power amplifiers, however, the limitations of the Volterra series become apparent; under present theory, a finite Volterra series can not handle the saturation that plagues any practical amplifier.

Attempts to implement a nonlinear precorrector based on a general Volterra series have been prohibitively computationally expensive in a system with memory. For example, a precorrector based on a general fifth order Volterra series requires over three thousand parameters to describe the nonlinear predistortion applied to the signal. Even where the nonlinear transform is implemented with look-up tables, such tables require too much memory to be practical. These difficulties have limited the general applicability of Volterra series predistorters.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor delineate the scope of the invention. Its sole purpose is to present some concepts of the invention in a simplified form as a prelude to the more detailed description that is presented later.

In accordance with one aspect of the present invention, a precorrection system is described for providing nonlinear precorrection to an input signal. A plurality of nonlinear function blocks each receive a constituent signal, derived from the input signal. Each constituent signal has an associated value and an associated delay. The nonlinear function blocks each output an intermediate signal having a value equal to the value of an associated memoryless nonlinear function evaluated at the value of the constituent signal. A summation component sums the plurality of intermediate signals to obtain a system output.

In accordance with another aspect of the invention, a method of precorrecting an input signal to counteract distortion from a distortion source is provided. A first memoryless nonlinear function is evaluated at a value associated with the input signal after a first predetermined delay to obtain a first intermediate value. A second memoryless nonlinear function is evaluated at a value associated with the input signal after a second predetermined delay to obtain a second intermediate value. The first and second intermediate values are then summed to obtain a precorrected output signal.

In accordance with yet another aspect of the present invention, a computer program product is provided for providing nonlinear precorrection to a nonlinear signal. The computer program product is operative within a hardware processor and located on a medium readable by the processor. A first nonlinear portion evaluates a first nonlinear function at a value associated with the input signal after a first predetermined delay to obtain a first intermediate value. A second nonlinear portion evaluates a second polynomial function at a value associated with the input signal after a second predetermined delay to obtain a second intermediate value. A summation portion sums the first and second intermediate values to obtain a precorrected output signal.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a nonlinear precorrection system in accordance with an aspect of the present invention.

FIG. 2 illustrates an exemplary implementation of a nonlinear precorrection system in accordance with one aspect of the present invention.

FIG. 3 illustrates an exemplary methodology for precorrecting an input signal to compensate for a distortion source in accordance with an aspect of the present invention.

FIG. 4 illustrates an exemplary implementation of a nonlinear precorrection system within a digital radio transmitter in accordance with one aspect of the present invention.

### DETAILED DESCRIPTION OF THE INVENTION

The present invention relates to a precorrection system and method for precorrecting for distortion induced by a related nonlinear distortion source. The present invention can be used generally for any signal processing application benefiting from precorrection for nonlinear distortion. As an exemplary application, the present invention can be used within a digital in-band, on-channel (IBOC) radio transmitter for correction of distortion caused by a power amplifier.

For many sources of distortion, the ideal inverse will not be causal or stable. For example, in some signal processing devices, the induced nonlinear distortion represents an error that leads the signal in phase. This is comparable to a traditional linear non-minimum phase filter, which shows similar properties and lacks a stable inverse. Although a stable inverse might not exist, a stable precorrector can be achieved, but at the cost of an associated delay.

For example, a power amplifier may be suffering from an error of e(n)=b*x(n−1), where b is a constant greater than one. Accordingly, the amplifier output for an particular input x(t) will be y(t)=x(t)+bx(t−1). It will be appreciated that the corresponding precorrection filter will have an impulse response of bⁿ as each successive sample adds a new power of b to the signal, going to infinity as n becomes large.

One approach to dealing with this instability is to provide a truncated version of the impulse response to the unstable system. For example, consider the following linear system. For a series of inputs, x(t)={ . . . 0, 1, −b, b², −b³, b⁴, 0}, a filter provides a output, y(t)={0, 1, 0, 0, 0, 0, b⁵} Changing the input slightly, to x(t)={ . . . 0, b^{-m}, b^{-(m-1)}, b^{-(m-2)} . . . b⁻¹, 0}, we obtain an output, y(t)={0, b^{-m}, 0, 0 . . . 0, 1}. For a large value of m, the b^{-m} term becomes negligible, leaving a response that resembles a delay in the system output. The present invention provides a precorrection system and method that provides an appropriate system response. This allows the necessary precorrection to be applied in a stable manner in exchange for a delay in signal processing. While the foregoing example deals with a linear system in order to better convey the basic idea, the actual invention also handles the equivalent nonlinear case.

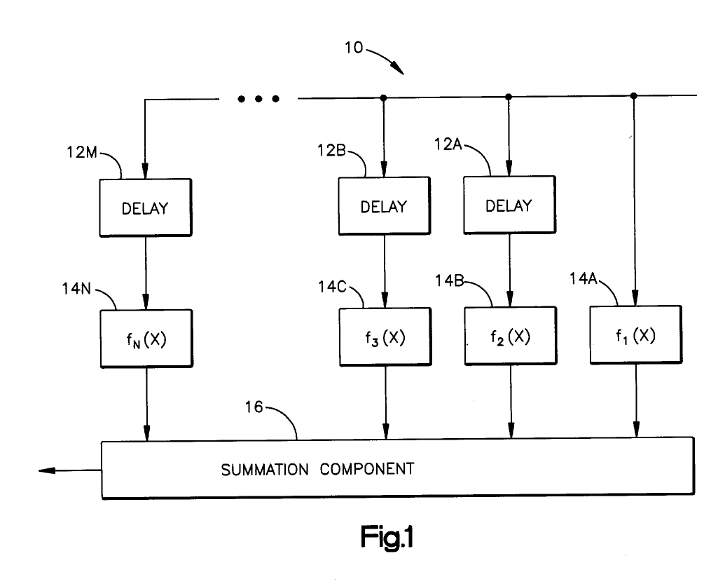

FIG. 1 illustrates a nonlinear precorrection system 10 in accordance with an aspect of the present invention. The nonlinear precorrection system 10 precorrects an information-carrying input signal to counteract the distorting effects of a source of nonlinear distortion associated with the system. For example, in an RF transmission system, the source of distortion can be a power amplifier. It will be appreciated that the illustrated system 10 can be implemented as a set of software instructions for a computer processor or as one or more hardware signal processing components. In an exemplary embodiment, the system 10 is implemented as part of a field programmable gate array.

The illustrated precorrection system 10 comprises one or more delay components 12A-12M. Each delay component delays an input signal by a predetermined amount. In an exemplary embodiment utilizing a plurality of delay components, the delay components can be connected in series, such that the output of each delay component reflects a cumulative delay over the preceding delay components. The period of delay introduced by each of the delay components can be determined according to various characteristics of the input signal and the associated source of distortion. For example, for precorrecting a digital input signal within an RF broadcasting system, the delays can depend on the bandwidth of the system and the sampling rate of the digital signal.

The precorrection system 10 further includes a series of nonlinear function blocks 14A-14N. The nonlinear function blocks 14A-14N can be implemented as function evaluation routines within a software program or one or more hardware components. Each nonlinear function block (e.g., 14A) represents a memoryless nonlinear function having one or more associated coefficients. By memoryless, it is meant that the function depends solely on one or more inputs at a given time. A memoryless function is not dependent on past inputs or outputs. By nonlinear, it is meant that the function need not meet the well-known conditions of linearity, such as superposition and scaling. The coefficients for the nonlinear function blocks are determined according to the characteristics of a source of nonlinear distortion associated with the system.

Each of the nonlinear function blocks 14A-14N receive a constituent signal for the precorrection. The constituent signal will have an associated value and an associated delay, although the associated delay may be zero. One or more of the constituent signals will comprise a delayed signal from one of the delay components 12A-12M. Thus, at least one of the nonlinear function blocks (e.g., 14C) receives a representation of the input signal reflecting a delay associated with a delay component (e.g., 12B). The remaining constituent blocks will comprise the input signal in an undelayed form. Each function block (e.g., 14A) evaluates its associated memoryless nonlinear function at a value associated with the received constituent signal and outputs an intermediate signal. As each nonlinear function block can receive the undelayed input signal or a delayed signal from one of the delay components, each intermediate signal can reflect any of a plurality of discrete delays within the input signal.

The outputted intermediate signals are provided to a summation component 16. The summation component 16 sums the intermediate signals from the series of nonlinear function blocks 14A-14N. The summation component 16 can be implemented by any suitable means, including an addition routine within a software program or any suitable hardware for summing signals. The output of the summation component 16 is an information-carrying signal precorrected to counteract a source of nonlinear distortion associated with the precorrection system.

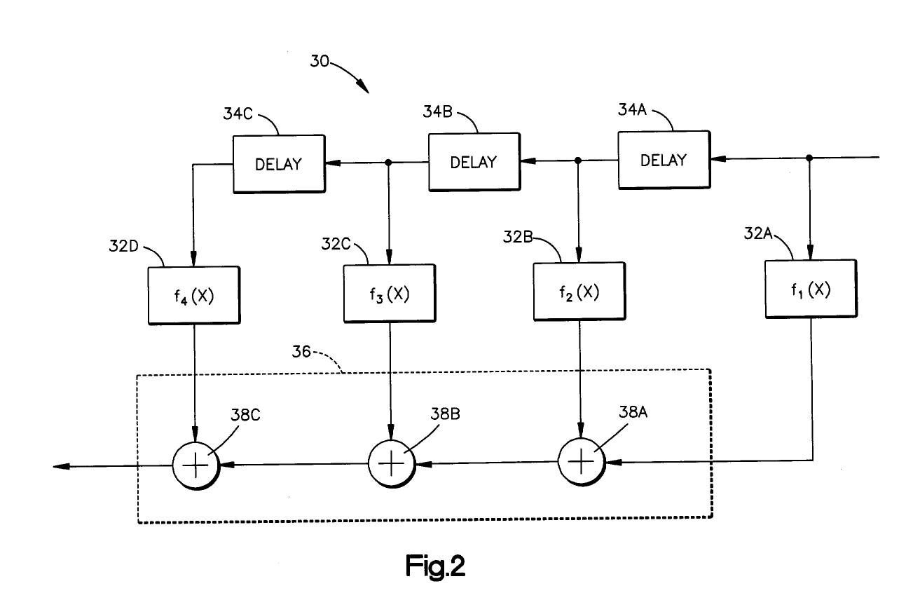

FIG. 2 illustrates an exemplary implementation 30 of a nonlinear precorrection system in accordance with one aspect of the present invention. In the illustrated implementation 30, the nonlinear precorrection system precorrects a digital information-carrying signal within an RF broadcasting system to nullify distortion introduced by a power amplifier. It will be appreciated that the precorrection system of the present invention can be implemented within other signal processing applications without departing from the spirit of the invention.

In the illustrated implementation, the memoryless nonlinear functions associated with the precorrection are polynomial functions. Accordingly, the illustrated precorrection system 30 comprises four polynomial function blocks 32A-32D. Each of the four polynomial function blocks 32A-32D represent a fifth order polynomial function, defined by five coefficients. It will be appreciated that the number of nonlinear function blocks and the specific nature of their associated memoryless nonlinear functions will vary with the desired applications. The above system could be implemented with radial basis functions, sinusoidal functions, or any other appropriate family of nonlinear functions.

The polynomial coefficients are provided as configuration parameters during a calibration process. The calibration process will be performed before system operation and can be repeated during operation to account for changes in the properties of the nonlinear distortion source associated with the system.

In the illustrated implementation, the coefficient values for the polynomial function blocks are selected to collectively approximate an inverse of the distortion introduced by the power amplifier. To accomplish this, a calibration signal can be input to the amplifier and amplifier and compared to a measured amplifier output. A parameter optimization procedure, such as a least squares regression, can be employed to select a set of parameters that minimize the following error function:

$$ϵ = {\sum }_{i = 1}^{4} {f}_{i} [ y ( t - {t}_{i} ) ] - x ( t ) \qquad Eq . 1$$

where:

ε is the error to be minimized;

f₁-f₄ are the polynomial functions of the precorrector;

tᵢ is a time delay associated with the i^{th} function

x(t) is the input to the amplifier; and

y(t) is the output of the amplifier at a time t.

Alternatively, the polynomial coefficients can be selected by directly estimating the distortion introduced by the amplifier. As above, a calibration signal is provided to the amplifier. The input and output of the amplifier are sampled and compared as part of a parameter optimization procedure. In this procedure, a set of parameters are chosen to minimize the difference in the precorrector output and the amplifier output. Once these parameters are determined, appropriate coefficients can be derived from them for use in the precorrector.

The illustrated system implementation 30 further comprises three delay components 34A-34C connected in series. Each of these delay components add a predetermined delay to a received signal. As the delays are connected in series, the output at each delay component (e.g., 34C) contains a delay associated with the delay component as well as the cumulative delay of the preceding delay components (e.g., 34A and 34B). The delay associated with each delay component is determined according to the bandwidth of the transmission system and the sample rate of the digital signal.

Turning to the operation of the precorrection system, an undelayed input signal is provided to a first polynomial function block 32A as a constituent signal. The first polynomial function block evaluates its associated polynomial function at the value of the undelayed signal to produce a first intermediate signal.

The undelayed input signal is also provided to a first delay component 34A. The first delay component adds a first delay to the signal to create a first delayed signal. This first delayed signal is provided to a second polynomial function block 32B as a constituent signal. The second polynomial function block 32B evaluates its associated polynomial function at the value of the first delayed signal to produce a second intermediate signal.

The first delayed signal is also received at a second delay component 34B. The second delay component 34B adds a second delay to the first delayed signal to produce a second delayed signal. The second delayed signal is provided to a third polynomial function block 32C. The third polynomial function block 32C evaluates its associated polynomial function at the value of the second delayed signal to produce a third intermediate signal.

The second delayed signal is also received at a third delay component 34C. The third delay component 34C adds a third delay to the second delayed signal to produce a third delayed signal. The third delayed signal is provided to a fourth polynomial function block 32D. The fourth polynomial function block 32D evaluates its associated polynomial function at the value of the third delayed signal to produce a fourth intermediate signal.

The illustrated system implementation 30 further includes a summation function 36 comprising three adders 38A-38C. A first adder 38A receives as its inputs the first intermediate signal from the first polynomial function block 32A and the second intermediate signal from the second polynomial function block 32B. The first adder 38A sums the two signals to produce a first combined signal. This combined signal is passed as one input to a second adder 38B.

The second adder 38B receives the third intermediate signal from the third polynomial function block 32C and the first combined signal as inputs. The second adder 38B sums the two signals to produce a second combined signal. A third adder 38C receives the fourth intermediate signal from the fourth polynomial function block 32D and the second combined signal as inputs. The third adder 38C sums the two signals to produce a system output. The system output is a digital, information-carrying signal that is precorrected to account for the distortion introduced by the power amplifier.

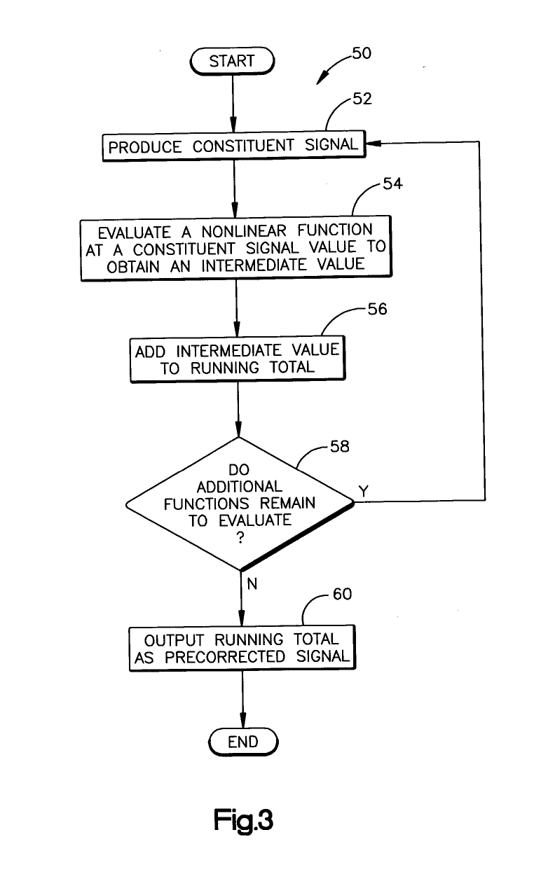

FIG. 3 illustrates an exemplary methodology 50 for precorrecting a digital input signal to compensate for a distortion source in accordance with an aspect of the present invention. In one pass through the illustrated methodology, a single digital sample value is produced for a precorrected output signal. While, for purposes of simplicity of explanation, the methodology of FIG. 3 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

The methodology begins at block 52, where a predetermined delay is applied to the input signal to produce a constituent signal. The predetermined delay can comprise a time period of any non-negative duration, including a zero delay.

In the course of the methodology, a plurality of constituent signals can be created, each with an associated delay. The delays associated with the delayed signals can be different, such that each constituent signal has a unique associated delay. In the exemplary methodology, the predetermined delay associated with a first constituent signal is zero. The delays associated with the constituent signals can be cumulative. Each successive constituent signal can be created by adding a delay to the previous constituent signal. Alternatively, each constituent signal can be produced by adding a predetermined delay directly to the undelayed input signal.

The methodology continues to block 54, where one of a plurality of memoryless nonlinear functions is evaluated at a value associated with the constituent signal. In the exemplary methodology, the value associated with the constituent signal is the signal amplitude, but other characteristics of the delayed signal can be used. The plurality of memoryless nonlinear functions will include a memoryless nonlinear function corresponding to each of the delayed signals created at block 52. The methodology proceeds to block 56, where the intermediate value is added to a running total.

The methodology then advances to decision block 58, where it is determined if more functions remain to be evaluated. Each memoryless nonlinear function is evaluated once in each pass through the methodology to produce a plurality of intermediate values. Accordingly, if there are functions that have not been evaluated, the methodology returns to block 52 to produce another constituent input signal. When all of the functions have been evaluated, the methodology proceeds to block 60.

Once all of the functions have been evaluated, the running total from block 56 contains an intermediate value derived from each of the memoryless nonlinear functions. At block 60, this running total is output as one sample value of a precorrected digital signal. The process then terminates.

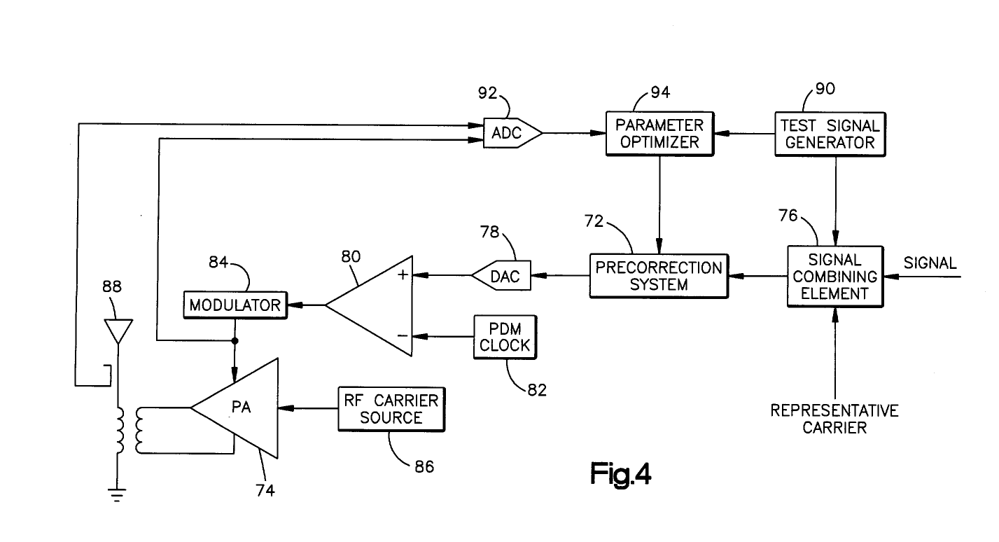

FIG. 4 illustrates an exemplary implementation of a nonlinear precorrection system within a digital radio transmitter 70 in accordance with one aspect of the present invention. By digital radio transmitter, it is intended to encompass both a radio transmitter having a combined digital and analog output, such as the Ibiquity Digital Corporation's IBOC digital radio system, and a radio transmitter having a solely digital output, such as the Digital Radio Mondiale (DRM). In the illustrated transmitter, the nonlinear precorrection system 72 precorrects a digital information-carrying signal within the transmitter 70 to nullify distortion introduced by a power amplifier 74. It will be appreciated that the precorrection system of the present invention can be implemented within other signal processing applications without departing from the spirit of the invention.

During operation, a digital information-carrying signal is combined with a representative carrier signal at a signal combining element 76. Appropriate techniques for combining two signals are known in the art, and the implementation of the signal combining element 76 will vary with the nature of the representative carrier signal. In the illustrated example, the representative signal is a DC carrier signal representing the power level of a radio frequency carrier signal associated with the transmitter 70. The combined signal is then passed to a precorrection system 72 in accordance with the present invention.

At the precorrection system 72, an appropriate predistortion is introduced into the information-carrying signal. The amount of predistortion introduced is determined according to an evaluation of a series of memoryless nonlinear functions. The result of this evaluation is a precorrected signal, which is passed to a digital-to-analog converter (DAC) 78.

The digital signal is converted into an analog signal at the DAC 78 and provided as one input to a comparator 80. The comparator 80 receives as its second input a ramped clock signal from a pulse duration modulation clock 82. The comparator 80 thus outputs a signal comprising a series of pulses, each having a duration dependent upon the amplitude of the analog information-carrying signal. These pulses are provided to a modulator 84.

The modulator 84 receives the signal pulses and translates them to appropriate amplitude values. It then provides a corresponding voltage to the power amplifier 74 as a voltage supply signal. A radio frequency carrier source 86 provides a radio frequency (RF) carrier signal to the amplifier. The RF carrier signal is amplified by a gain varying with the voltage supply signal provided by the modulator 84. The amplified signal is provided to an antenna 88 for broadcast.

In accordance with one aspect of the invention, the precorrector of the present invention can be made adaptive to reflect changes in the properties of the power amplifier 74. For example, the nonlinear distortion introduced by the amplifier can vary with the temperature, age, or power level of the amplifier. Accordingly, the precorrection provided at the precorrection system 72 can be changed in circumstances where one or more of these factors are likely to change. For example, the system can be calibrated each time the power level of the amplifier is changed.

During calibration, a test signal is provided from a test signal generator 90 to the signal combining element 76 to be combined with a representative carrier signal. The test signal can contain a short test pattern having signal values representative of the range of signals experienced by the system during operation. The combined signal is converted to a digital signal and modulated at the comparator 80 and the modulator 84. Before the signal is provided to the power amplifier 74 as a voltage supply, it is sampled and fed back to an analog-to-digital converter (ADC) 92. Prior to reception at the ADC 92, the sampled feedback signal can be filtered and otherwise preprocessed to produce a clean, easily convertible signal.

An RF carrier signal is amplified at the power amplifier 72 and output at the antenna 88. A second feedback signal is sampled at the antenna 88 and provided to the ADC 92. The second sampled feedback signal can be filtered and downmixed to facilitate conversion of the signal.

The ADC 92 produces digital representations of the two feedback signals. The signals are then provided to a parameter optimizer 94. At the parameter optimizer, a set of optimal coefficients is determined for the polynomial functions within the precorrection system 72. The precorrection system 72 is updated with the optimal components to end the calibration process. For example, in an exemplary implementation of the precorrection system utilizing four fifth-order polynomial functions, the parameter optimizer 94 can determine around twenty optimal coefficients during calibration of the system. The number of necessary coefficients will clearly vary with the selected nonlinear functions. The parameter optimizer 94 can include any of a number of optimization algorithms including evolutionary methods, Bayesian statistical methods, or gradient search techniques. In an exemplary embodiment, the parameter optimizer uses a least square optimization algorithm to determine appropriate parameters.

In one implementation, the coefficient values for the nonlinear function blocks are selected to collectively approximate an inverse of the distortion introduced by the power amplifier 74. For a precorrection system having N representative functions, the parameter optimizer minimizes the error over the following equation:

$$ϵ = {\sum }_{i = 1}^{N} {f}_{i} [ y ( t - {t}_{i} ) ] - x ( t ) \qquad Eq . 2$$

where:

ε is the error to be minimized;

fᵢ is the ith representative function

tᵢ is a time delay associated with the i^{th} function

x(t) is the input to the amplifier; and

y(t) is the output of the amplifier at a time t.

The optimal parameters for the precorrection system 72 are those giving a minimum value for this error function

Alternatively, the function coefficients can be selected by directly estimating the distortion introduced amplifier. In this procedure, a set of parameters is chosen to minimize the following equation:

$$ϵ = {\sum }_{i = 1}^{N} {f}_{i} [ x ( t - {t}_{i} ) ] - y ( t ) \qquad Eq . 3$$

where:

ε is the error to be minimized;

N is the number of representative functions;

fᵢ is the i^{th} representative function;

tᵢ is a time delay associated with the ith function;

x(t) is the input to the amplifier at a time t; and y(t) is the output of the amplifier.

Once a solution for this optimization problem is found, appropriate coefficients can be derived from the solution for use in the precorrector.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, the following is claimed:

1. A precorrection system that provides nonlinear precorrection to an input signal, comprising:
a plurality of nonlinear function blocks, each receiving a constituent signal, derived from the input signal and having an associated value and an associated delay, and outputting an intermediate signal having a value equal to that of an associated memoryless nonlinear function evaluated at the value of the constituent signal; and
a summation component that sums the plurality of intermediate signals to obtain a system output.

2. A system as set forth in claim 1, the system further comprising at least one delay component, said at least one delay component providing the delay associated with at least one of the constituent signals.

3. A system as set forth in claim 2, wherein at least one delay component comprises a plurality of delay components that are connected in series.

4. A system as set forth in claim 1, each of the constituent signals received at the plurality of nonlinear function blocks having a different associated delay.

5. A system as set forth in claim 1, wherein the plurality of nonlinear function blocks includes a first nonlinear function block, the constituent signal received at the first nonlinear function block having a delay of zero.

6. A system as set forth in claim 1, wherein the memoryless nonlinear function associated with each nonlinear function block is a polynomial function.

7. A system as set forth in claim 1, wherein the plurality of nonlinear function blocks and the summation component are implemented as part of a field programmable gate array.

8. A system as set forth in claim 1, wherein the system is implemented as part of a digital broadcasting transmitter.

9. A system as set forth in claim 1, wherein the system is implemented as part of a combined digital and analog broadcasting transmitter.

10. A system as set forth in claim 9, wherein the transmitter includes a parameter optimization component that determines an optimal set of coefficients associated with the plurality of nonlinear function blocks in response to at least one feedback signal.

11. A method of precorrecting an input signal to counteract distortion from a distortion source comprising:
evaluating a first memoryless nonlinear function at a value associated with the input signal after a first predetermined delay to obtain a first intermediate value;
evaluating a second memoryless nonlinear function at a value associated with the input signal after a second predetermined delay to obtain a second intermediate value; and
summing at least the first and second intermediate values to obtain a precorrected output signal.

12. A method as set forth in claim 11, further comprising the step of evaluating a third memoryless nonlinear function at a value associated with the input signal after a third predetermined delay to obtain a third intermediate value, the precorrected output signal comprising the sum of at least the first, second, and third intermediate values.

13. A method as set forth in claim 11, wherein the first and second nonlinear functions are polynomial functions.

14. A method as set forth in claim 11, further comprising the following:
sampling the input signal after it has been exposed to the distortion source;
determining a set of optimal function coefficients for at least one of the first memoryless nonlinear function and the second memoryless nonlinear function from the sampled signal; and
changing at least one function coefficient associated with at least one of the first and second memoryless nonlinear functions according to the determined optimal function coefficients.

15. A method as set forth in claim 14, wherein determining a set of optimal function coefficients includes minimizing an error function related to one or more characteristics of the amplifier.

16. A method as set forth in claim 14, wherein determining a set of optimal function coefficients includes minimizing an error function related to one or more characteristics of an inverse representation of the amplifier.

17. A method as set forth in claim 14, wherein determining a set of optimal function coefficients includes the use of a least squares optimization algorithm.

18. A computer program product, operative within a hardware processor and located on a medium readable by the processor, for providing nonlinear precorrection to a nonlinear signal comprising:
a first nonlinear portion that evaluates a first memoryless nonlinear function at a value associated with the input signal after a first predetermined delay to obtain a first intermediate value;
a second nonlinear portion that evaluates a second memoryless nonlinear function at a value associated with the input signal after a second predetermined delay to obtain a second intermediate value; and
a summation portion that sums the first and second intermediate values to obtain a precorrected output signal.

19. A computer program product as set forth in claim 18, further comprising a parameter optimization portion that determines a set of optimal function coefficients for at least one of the first nonlinear function and the second nonlinear coefficient from a sampled feedback signal.

20. A computer program product as set forth in claim 19, further comprising at least one delay portion that provides the first and second predetermined delay to the input signal.
